(19) United States
(12) Patent Application Publication
(10) Pub. No.: US 2009/0191850 A1
(43) Pub. Date: Jul. 30, 2009

(54) Alert Method, Apparatus, System and Program Product

(75) Inventors: Walter W. Cardwell, III, Austin, TX (US); James O. Guleke, II, Austin, TX (US); Kyle David Witt, Arlington, TX (US)

Correspondence Address: DILLON & YUDELL LLP, 8911 NORTH CAPITAL OF TEXAS HWY, SUITE 2110, AUSTIN, TX, 78759, US

(73) Assignee: Spitfire Ltd., Austin, TX (US)

(21) Appl. No.: 12/363,273

(22) Filed: Jan. 30, 2009

Related U.S. Application Data
(60) Provisional application No. 61/024,769, filed on Jan. 30, 2008.

(51) Int. Cl. H04M 1/663

(52) U.S. Cl. 455/412.2

(57) ABSTRACT

According to one embodiment, a mobile phone wirelessly receives an alert request from a separate alert triggering device via a first wireless interface of the mobile phone. In response to the alert request, the mobile phone automatically transmits an alert message utilizing wireless radio frequency communication via a second wireless interface of the mobile phone and a wireless wide area network. The communication of alerts can further be supported by the viral transmission of alert relay requests that propagate opportunistically in an attempt to reach a communication device, such as a mobile phone or WAP, that is capable of delivering an alert relay message to an electronic communication destination.

### PRIORITY CLAIM AND CROSS-REFERENCE

The present application claims priority to U.S. patent application Ser. No. 61/024,769, filed Jan. 30, 2008, which is incorporated herein by reference in its entirety. The present application is also related to U.S. Pat. Nos. 6,199,726 and 7,140,515, which are incorporated herein by reference in their entireties.

### BACKGROUND

1. Technical Field

The present disclosure relates in general to an alert method, apparatus, system and program product.

2. Description of the Related Art

A variety of devices are carried by individuals to enhance personal security, including among others, weapons, mobile telephones, whistles, audible alarm units, and chemical irritant dispensers.

### SUMMARY

According to one embodiment, a mobile phone wirelessly receives an alert request from a separate alert triggering device via a first wireless interface of the mobile phone. In response to the alert request, the mobile phone automatically transmits an alert message utilizing wireless radio frequency communication via a second wireless interface of the mobile phone and a wireless wide area network. The communication of alerts can further be supported by the viral transmission of alert relay requests that propagate opportunistically in an attempt to reach a communication device, such as a mobile phone or WAP, that is capable of delivering an alert relay message to an electronic communication destination.

### BRIEF DESCRIPTION OF THE DRAWINGS

FIG. 1 is an exemplary embodiment of an environment in which the claimed methods, apparatus, systems and program products may advantageously be practiced;

FIG. 2A is a high-level block diagram of an exemplary embodiment of a mobile phone from FIG. 1;

FIG. 2B is a layer diagram of an exemplary software configuration of a mobile phone in accordance with one embodiment;

FIG. 3 is a high level logical flowchart of an exemplary method of wirelessly providing an alert request from an alert triggering device to a communication device in accordance with one embodiment;

FIG. 4 is a high level logical flowchart of an exemplary method of wirelessly providing an alert relay request to a communication device in accordance with one embodiment; and

FIGS. 5A-5B together form a high level logical flowchart of an exemplary method of providing an alert in accordance with one embodiment.

### DETAILED DESCRIPTION OF ILLUSTRATIVE EMBODIMENT

### Exemplary Environment

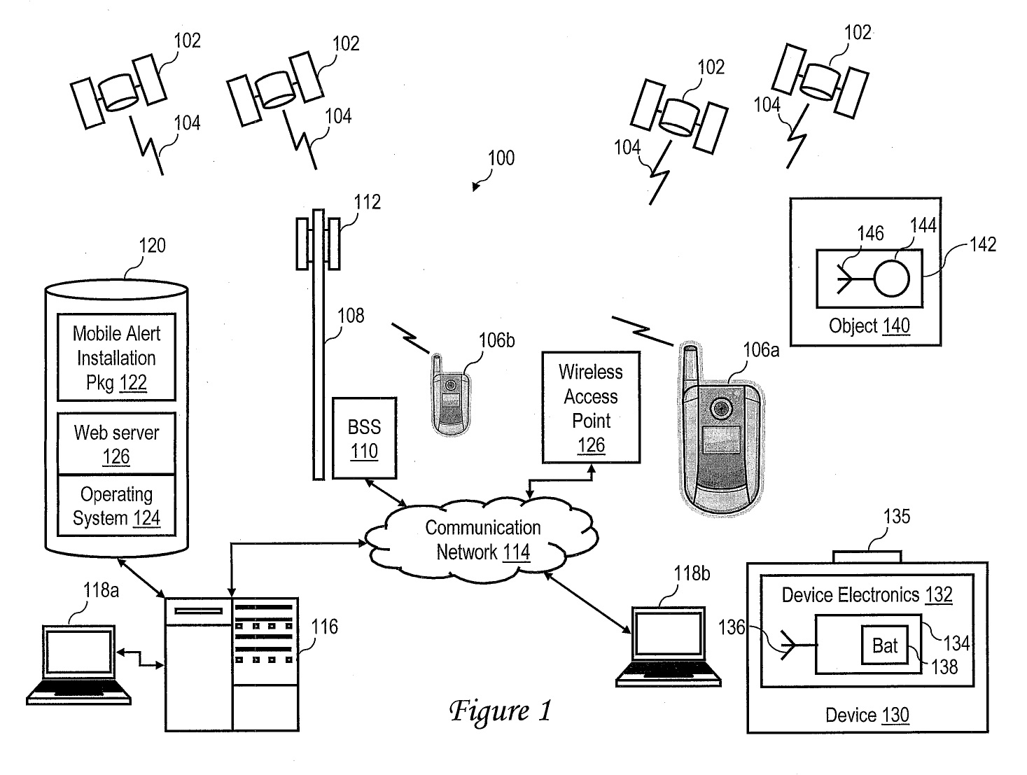

With reference now to the figures, and in particular with reference to FIG. 1, there is depicted an exemplary embodiment of an environment 100 in which the methods, apparatus, systems and program products claimed herein may advantageously be practiced.

As shown, environment 100 includes a constellation of earth-orbiting global positioning system (GPS) satellites 102. As is known in the art, GPS satellites 102 continuously emit radio frequency GPS signals 104, which enable GPS-equipped devices, such as mobile phones 106a and 106b, to continuously determine their position, velocity, and bearing as long as a sufficient number of GPS satellites 102 can be acquired.

Environment 100 further includes one or more wireless wide-area network (WAN) communication systems. One wireless WAN communication system includes a plurality of geographically distributed cellular towers 108 and base station systems (BSS) 110 (only one of each is illustrated for simplicity). Cellular towers 108 include one or more antennae 112 supporting long range two-way radio frequency communication with mobile telephones 106 and other wireless devices. The radio frequency communication between antennae 112 and mobile phones 106 may utilize radio frequency signals 36 conforming to any known or future developed wireless communication protocol, for example, CDMA, GSM, EDGE, 3G, 4G, WiMAX, HiperMAN, etc. The information transmitted over-the-air by BSS 110 and cellular communication tower 108 to and from mobile phones 106 may be further transmitted to or received from one or more additional circuit-switched or packet-switched communication network(s) 114, including, for example, the Internet.

The wireless WAN communication systems may further include one or more wireless access points (WAPs) 126 capable of communicating wirelessly with mobile phones 106 and/or other wireless-enabled devices (e.g., mobile computing devices, point-of-sale devices, sensors, etc.) in accordance with an 802.xx or other wireless communication protocol. Many businesses (e.g., a convenience store, grocery store, bank, etc.) have a large number of electronic systems on site, some of which have an address or location assigned to them. These systems may include, for example, the following:
(1) point-of-sale or cash register system;
(2) outside payment authorization system at a fuel pump;
(3) inside payment authorization system;
(4) ATM machine with camera and independent communication wiring;
(5) business computer system for email/Internet access, etc.;
(6) local wireless network;
(7) land line telephone;
(8) panic button for contacting security dispatcher and/or emergency services;
(9) inside and outside security cameras, which frequently serve as IP network nodes;
(10) recorders for security cameras;
(11) RFID scanner at checkout tied to inventory control software;
(12) electronic communication system for wiring money; and
(13) mobile phones of employees and patrons.
   Any of these electronic systems can be appropriately programmed to operate as a WAP 126.

Data processing systems, such as a server computer 116 and client devices 118a, 118b, are further coupled to communication network 114. Server computer 116 has associated data storage 120 containing a mobile alert installation package 122 for distribution to mobile phone(s) 106, as well as software for operating server computer 116, such as a server operating system 124 and a web server 126. Communication network 114 may be employed to communicate data between any of server computer 116, client computer system(s) 118a, 118b, WAPs 126 and mobile phones 106. For example, as described further below, communication network 114 may be utilized to communicate-one or more alert messages, a voice channel, and/or route waypoints from a mobile phone 106 to server computer system 116 and/or client computer systems 118 via WAP 126 and/or BSS 110. In addition, communication network 114 may be utilized to communicate software, such as a mobile alert application, from server 116 to a mobile phone 106 for installation on the mobile phone 106 via WAP 126 and/or BSS 110.

Environment 100 further includes an alert triggering device 130, which is preferably but not necessarily a small, humanly transportable, battery-powered device such as a pepper spray dispenser (e.g., the Spitfire® pepper spray dispenser disclosed in U.S. Pat. No. 6,199,726). Alert triggering device 130 is not limited, however, to pepper spray dispensers. Any device that will accept the electronics required to function as herein described can be utilized (e.g., flashlight, watch, jewelry, fountain pen, key chain attachment, automobile keyless entry remote, pistol handle, mobile phone, PDA, etc.). As shown, alert triggering device 130 includes device electronics 132, which in some embodiments includes at least a wireless transmitter 134 with associated antenna 136 and a battery 138. In other embodiments, additional circuitry may be included, such as a flash memory, RFID tag, etc. Alert triggering device 130 further includes an actuator 135, such as an alert button or other actuator, that when actuated initiates transmission of an alert request, as described further below.

Environment 100 may optionally further include an object 140 (e.g., hair clip, jewelry, clothing item, or any other humanly transportable object) including a dot 142. Dot 142, which is preferably implemented as a miniature passive or active electronics package 144. Dot 142 may further include an antenna 146. The purpose of dot 142 is to create a network of mobile phones 106 and other wireless devices using wireless signals (e.g., including BlueTooth®, RFID, and/or wireless telephony, etc.) to communicate the location, time and/or identity of an activated dot 142 on a person to a specified recipient (e.g., the email address of a first responder identified by dot 142). Thus, even if mobile phone 106 is lost, stolen, destroyed, disabled or discarded, each time an activated dot 142 passes within the range of any appropriately enabled mobile phone 106 or other wireless device (e.g., point-of-sale terminal or wireless access point 126), the identity, location and/or time of dot 142 is transmitted to the electronic communication destination (e.g., email address, instant messaging account, or telephone number) specified by the activated dot 142. This operation can create a progressive track of GPS coordinates to assist first responders to locate dot 142 and thus the person carrying it. As mobile phones 106 are increasingly enabled with GPS and wireless communication hardware and software, this network of integrated communicating devices will become increasingly effective for locating persons in alert (emergency) situations with an activated dot 142.

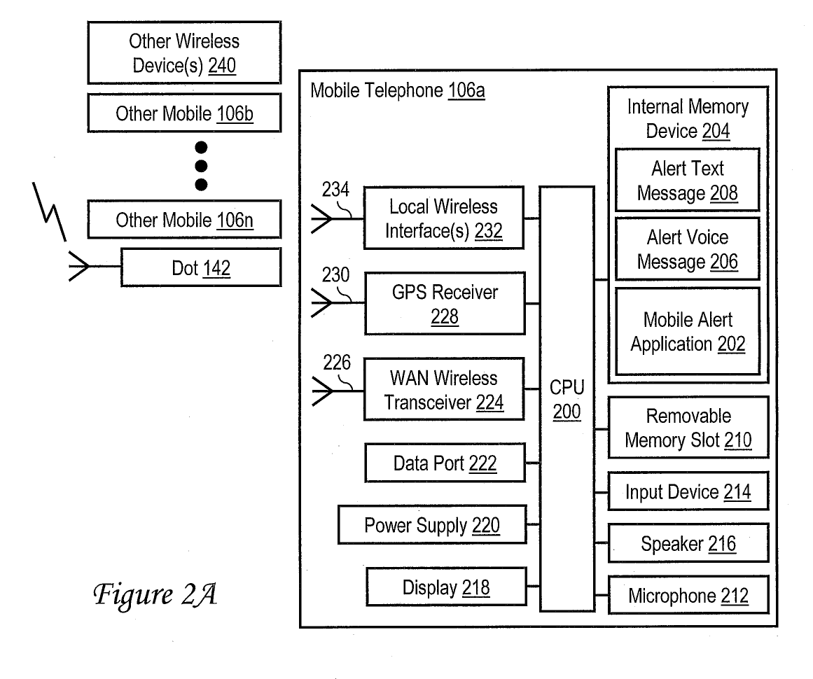

Referring now to FIG. 2A, there is illustrated a high-level block diagram of an exemplary embodiment of a mobile phone 106 of FIG. 1. As illustrated, mobile phone 106 includes a central processing unit (CPU) 200 that controls the operation of mobile phone 106 in accordance with a mobile alert application 202. As shown, CPU 60 is coupled, either directly or indirectly to a variety of different components within mobile phone 12. For example, mobile phone 106 includes an internal memory device 204 for storing a mobile alert application 202, as well as a pre-recorded alert voice message 206 and an alert text message 208. If mobile phone 106 includes text-to-speech processing capability, a separate pre-recorded alert voice message 206 can be omitted. The storage provided by internal memory device 204 may be further augmented by a removable storage medium inserted within removable memory slot 210. Alert messages 206, 208 can be any message that the user wants to compose, associate with mobile alert application 202 and send to any of one or more electronic communication destinations (e.g., email address, instant messaging account, or telephone number) in response to receipt of an alert request received from alert triggering device 130.

In addition to microphone 212 through which mobile phone 106 may receive a voice signal and/or voice commands, mobile phone 106 may include a number of other input/output (I/O) devices. For example, mobile phone 106 may include at least one manually manipulable input device 214 (e.g., numeric buttons and/or a touch screen), a speaker 216 for presenting audio output, and a display 218 through which mobile phone 106 may present graphical, textual or iconic information to the user.

Mobile phone 106 is equipped with a power supply 220 that powers CPU 200 and the other components of mobile phone 106. Power supply 220 includes a battery and may further have an associated power port through which the battery may be charged from an AC power source. Alternatively, the battery within power supply 220 may be charged utilizing a wireless inductive charging device, as is known in the art.

To reduce power demands on the battery, mobile alert application 202 preferably runs in the background in a low power mode to detect the alert request from alert triggering device 130. Upon detection of the alert request, mobile alert application 202 runs with higher priority and initiates the communication described herein.

Mobile phone 106 further includes a GPS receiver 228 and associated GPS antenna 230 that receive GPS signals 104 from GPS satellites 102. GPS receiver 228 processes GPS signals 104 to present to CPU 200 time-stamped waypoints, which include at least a time, latitude and longitude. If at least four GPS satellites 102 have been acquired, the time-stamped waypoints presented to CPU 200 by GPS receiver 228 may further include an elevation. As discussed further below, the time and position information supplied by GPS receiver 228 is utilized by mobile alert application 202 running on CPU 200 to communicate waypoints of a route traversed by mobile phone 106 following receipt of an alert request from an alert triggering device 130.

Mobile phone 106 supports two-way wireless WAN communication with cellular telephone tower 108 with WAN wireless transceiver 224 and its associated antenna 226. As known to those skilled in the art, WAN wireless transceiver 224 includes a receiver for receiving radio frequency signals and a transmitter for transmitting radio frequency signals. As discussed in greater detail below, the radio frequency signals may include GPS waypoints, alert text message 208, alert voice message 206, and one or two-way voice communication. The data sent and received by WAN wireless transceiver 224 may alternatively or additionally be communicated via an optional data port 222, which may employ short range wired or wireless communication (e.g., RS-232 or infrared).

The data sent and received by WAN wireless transceiver 224 may alternatively or additionally be communicated via one or more local wireless interface(s) 232 and associated antennae 234. For example, local wireless interface(s) may include interfaces for 802.xx, BlueTooth®, 900 MHz communication, or the like. Utilizing such technologies, mobile phone 106 may communicate with dot 142, other mobile phones 106, or other wireless devices 240. In this manner, mobile phone 106 may communicate alert voice and text messages to a distributed network of devices.

With reference now to FIG. 2B, there is illustrated a layer diagram of an exemplary software configuration of a mobile phone 106 in accordance with one embodiment. As illustrated, the software configuration of mobile phone 106 includes at a lowest level an operating system (OS) 250 that provides a collection of services, such as thread scheduling, memory management, interrupts, etc., that may be accessed by higher-level software. Running on top of operating system 250 is a runtime environment 252, such as one of the JAVA or BREW runtime environments. Additionally, the software configuration of mobile phone 106 includes a mobile alert application 202 running on top of runtime environment 252. Mobile alert application 202 may be installed on mobile phone 106a by pulling or pushing mobile alert installation package 122 over-the-air from server computer 120, for example, via the wireless WAN and WAN wireless transceiver 224.

### Exemplary Methods

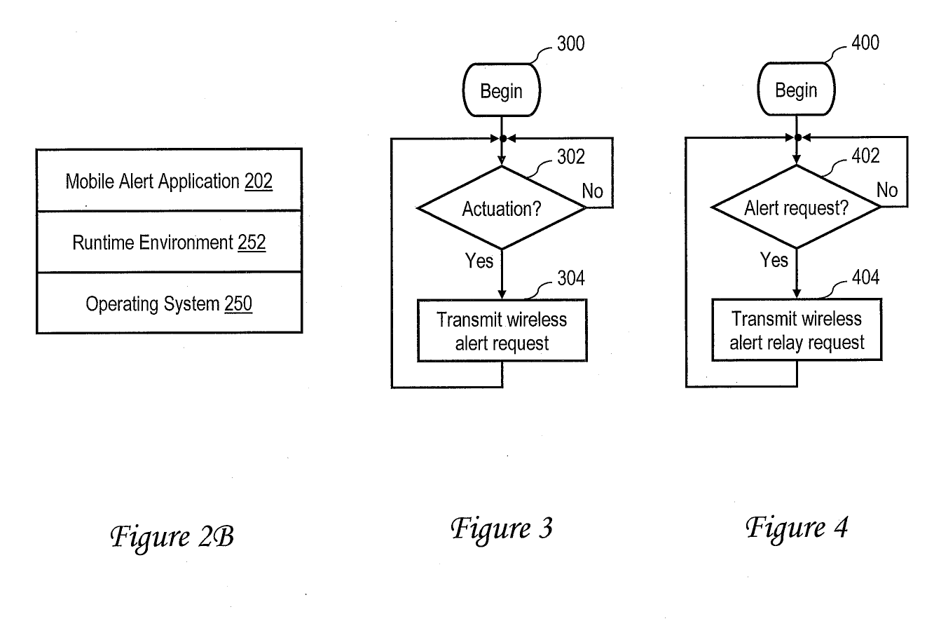

Referring now to FIG. 3, there is depicted a high level logical flowchart of an exemplary method of providing an alert request utilizing an alert triggering device 130 in accordance with one embodiment. The process begins at block 300, for example, with a user carrying alert triggering device 130 in the user's hand, in or on the user's clothing, in a purse, etc. As indicated by blocks 302-304, in response to user actuation of actuator 135 (e.g., pressing actuator 135 three times within three seconds), device electronics 132 of alert triggering device 130 is activated and transmits an alert request wirelessly by BlueTooth® (or other qualified RF wireless signal) to the user's mobile phone 106 (e.g., mobile phone 106a) and, if present, to dot 142 via BlueTooth® (or other qualified RF wireless signal) and/or RFID technology. The alert request may simply be a predetermined signal pattern signifying an alert to a recipient device and/or may further include a serial number, personal identification number (PIN) or other identification of alert triggering device 130, device electronics 132, and/or the user. Thereafter, the process returns to block 302, which has been described.

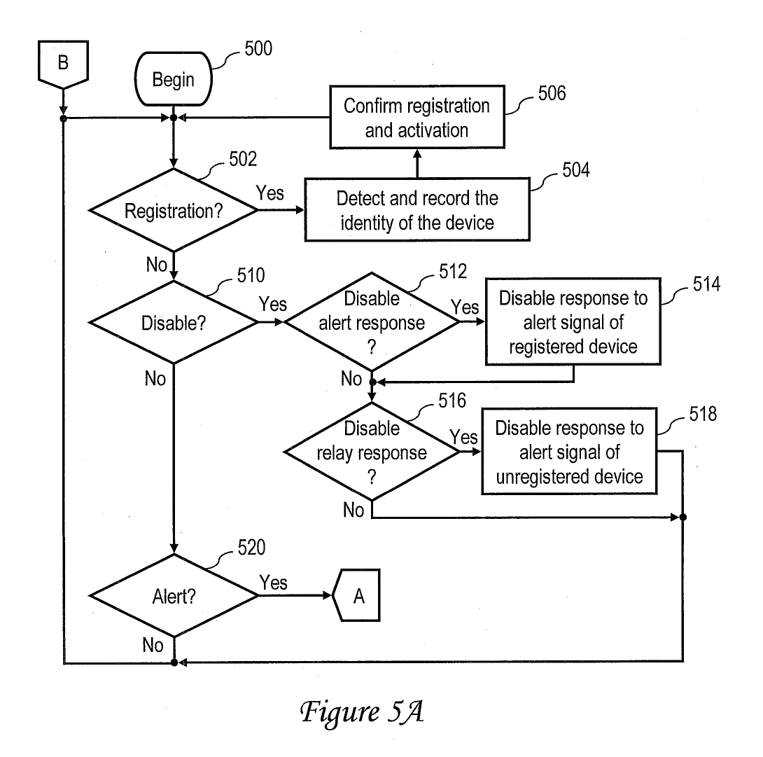

With reference now to FIG. 4, there is depicted a high level logical flowchart of an exemplary method of providing an alert relay request in accordance with one embodiment. The process begins at block 400, for example, with a user carrying at least one dot 142 on or in the user's clothing, on or in a personal accessory item (e.g., ring, necklace, pendant, keyless entry remote), on or in a purse, etc. As indicated by blocks 402-404, in response to receiving an alert request, such as that transmitted at block 304 of FIG. 3, electronics package 144 of dot 142 is activated and transmits an alert relay request wirelessly by BlueTooth® (or other qualified RF wireless signal) and/or RFID technology. The alert relay request may simply be a predetermined signal pattern signifying existence of an alert condition to a recipient device. The alert relay request may further include a serial number, personal identification number (PIN) or other identification of alert triggering device 130, dot 142 and/or the user. In addition, the alert relay request may specify a desired electronic communication destination (e.g., telephone number, instant messaging mailbox, and/or email address) to which an alert relay message is requested to be delivered. Thereafter, the process returns to block 402, which has been described.

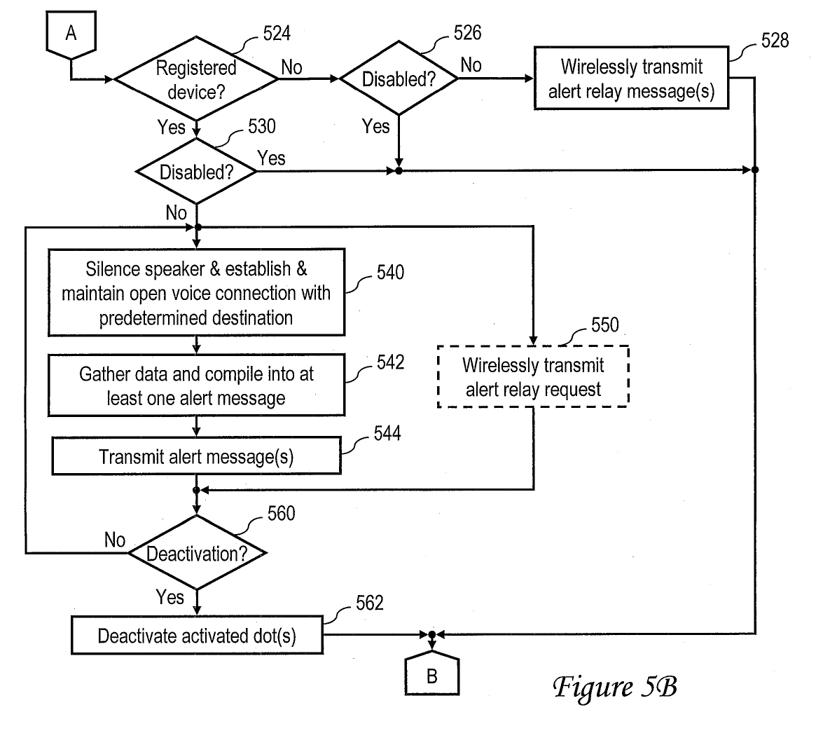

With reference now to FIG. 5A, there is illustrated a high level logical flowchart of an exemplary method of operation of a mobile alert application 202 in accordance with one embodiment. The illustrated process begins at block 500 with mobile alert application 202 executing on a communication device, such as a mobile phone 106, as will hereafter be assumed. It should be understood, however, that mobile alert application 202 is not limited to such applications, and can alternatively be executed by any WAP 126 or other communication device.

In at least one exemplary embodiment, mobile alert application 202 begins execution when mobile phone 106 is powered on and is executed in the background by CPU 200 of mobile phone 106 until mobile phone 106 receives an input intended for mobile alert application 202. In response to receipt of an input intended for mobile alert application 106, for example, via a local wireless interface 232 or input device 214, mobile phone 106 provides the input to mobile alert application 202.

In response to receipt of the input, mobile alert application 202 determines the type of the input. If mobile alert application 202 determines at block 502 that the input is a registration request, the process proceeds to block 504, which illustrates mobile alert application 202 detecting and recording in non-volatile storage (e.g., internal memory device 204) an identification of an alert triggering device 130 requesting registration with mobile phone 106. The identification, which can include, for example, a serial number, personal identification number (PIN) or other identification of alert triggering device 130, can be received by mobile phone 106 and mobile alert application 202 via a local wireless interface 232, data port 222, microphone 212 and/or input device 214.

In one embodiment, the registration request detected at block 502 is a menu command entered via input device 214, which registration request causes mobile alert application 202 to prompt user actuation of actuator 135 of alert triggering device 130. User actuation of actuator 135 causes device electronics 132 of alert triggering device 130 to transmit an RF alert request, which as described above includes the identification of alert triggering device 130 in at least one embodiment. Mobile alert application 202 receives the identification of alert triggering device 130 via a local wireless interface 232 and, in response to receipt thereof, stores the identification of alert triggering device 130 in non-volatile storage (e.g., internal memory device 204) as a device registered to broadcast an alert message via mobile phone 106. During this registration process, mobile alert application 202 does not propagate an alert message in response to the alert request.

Following block 504, the process proceeds to block 506, which depicts mobile alert application 202 providing confirmation of the successful registration of alert triggering device 130 with mobile alert application 202 and activation of an alert mode of mobile alert application 202. The confirmation can include, for example, the presentation of a confirmation within display 218, an audio presentation via speaker 216, and/or vibration of mobile phone 106 a predetermined number of times (e.g., 3). In at least one embodiment in which the confirmation of registration includes vibration of mobile phone 106, mobile alert application 202 thereafter disables vibration of user mobile phone 106 so the user can detect inadvertent activation of mobile alert application 202 and/or to confirm that the alert mode of mobile alert application 202 is activated.

During the registration process, mobile alert application 202 may optionally further program one or more dots 142 with some or all of the content of an alert relay request via local wireless interface 232. Following the conclusion of the registration process, the process returns to block 502.

Returning to block 502, if the input received by mobile alert application 202 is not a registration request, the process passes to block 510, which depicts mobile alert application 202 determining whether or not the input is a disable request. The disable request can comprise, for example, selection of a menu entry of mobile alert application 202 followed by entry a four-digit security code or PIN. If the input is a disable request, mobile alert application 202 further determines at blocks 512 and 516 whether the disable request requests disabling of a response to an alert request of a registered alert triggering device 130 and/or disabling of response to alert requests of non-registered devices. Responsive to the disable request, mobile alert application 202 may disable response to an alert request received from a registered alert triggering device 130 (block 512) and/or disable response to an alert relay request received from a non-registered device, such as a dot 142, another mobile phone 106 or other communication device (block 518). Thereafter, the process returns to block 502, which has been described.

Referring again to block 510, if the input received by mobile alert application 202 is not a disable request, mobile alert application 202 determines at block 512 whether or not the received input is an alert request or alert relay request. If not, the process returns to block 502, which has been described. If, however, the input is an alert request or alert relay request (e.g., received via antenna 234 and local wireless interface 232), the process passes through page connector A to FIG. 5B, which is described below.

Referring now to FIG. 5B, there is depicted a high level logical flowchart of an exemplary method by which a communication device, such as a mobile phone 106, responds to an alert request or alert relay request in accordance with one embodiment. The process continues from FIG. 5A at page connector A and proceeds to block 524, which illustrates mobile alert application 202 determining whether the request received at block 520 of FIG. 5A includes an identification of an alert triggering device 130 registered with mobile phone 106. That is, mobile alert application 202 determines if the request is an alert request containing a device identification of an alert triggering device 130 previously registered with mobile phone 106, as indicated by storage of a corresponding identification in non-volatile storage (e.g., internal memory device 204) of mobile phone 106.

If not, the process passes to block 526, which depicts mobile alert application 202 determining if response to alert relay requests from unregistered devices is disabled, as discussed above with reference to block 518. If so, mobile alert application 202 ignores the alert relay request received at block 520, and the process returns to block 502 of FIG. 5A through page connector B. If, however, mobile alert application 202 determines at block 526 that response of mobile alert application 202 to alert relay requests of unregistered devices has not been disabled, the process passes to block 528.

At block 528, mobile alert application 202 wirelessly transmits one or more RF alert relay messages via local wireless interface 232 and/or WAN wireless transceiver 224 of mobile phone 106 on behalf of the unregistered device. In at least one embodiment, the alert relay message indicates (i) the identity of mobile phone 106 (e.g., mobile phone 106a) that issued alert relay message (ii) the approximate location of the device (e.g., dot 142, mobile phone 106b or WAP 126) issuing the alert relay request (where location can be determined by any available means, including GPS coordinates, AGPS, triangulation, and/or physical street address), and (iii) a date/time. The alert relay message may optionally further include an indication of the identity of a source device that originally issued an alert request and/or its user. If mobile phone 106 transmits the alert relay message over the wireless WAN, mobile alert application 202 preferably directs the alert relay message to an electronic communication destination (e.g., telephone number, instant messaging mailbox, email address or other destination of electronic communication) indicated in the alert relay request. Following block 528, the process passes through page connector B to block 502 of FIG. 5A, which has been described.

It will be appreciated that in some embodiments, mobile alert application 202 filters out and does not respond to alert relay requests of dots 142 that are affiliated with the user of alert triggering device 130 since any alert relay messages transmitted in response to such alert relay requests would be duplicative of the alert message(s) (see, e.g., block 544) issued by mobile alert application 202 in response to an alert request. Such filtering can be accomplished by placing the user's dot(s) 142 within the range of local wireless interface 232 during the registration process depicted at blocks 502-506 so that mobile alert application 202 can query and record in internal memory device 204 the identification of each of the user's dot(s) 142. Such recorded identifications can then be utilized to filter out the alert relay requests of the affiliated dot(s) 142.

In response to a determination at block 524 that the request received at block 520 is an alert request of a registered alert triggering device 130, mobile alert application 202 determines at block 530 whether or not response to alert requests from registered devices is disabled, as discussed above with reference to block 514 of FIG. 5A. If so, mobile alert application 202 ignores the alert request received at block 520, and the process returns to block 502 of FIG. 5A through page connector B. If, however, mobile alert application 202 determines at block 530 that response of mobile alert application 202 to alert requests of registered devices has not been disabled, the process passes to block 540.

Block 540 depicts mobile alert application 202 silencing speaker 216 of mobile phone 106 so that speaker 106 does not present any audio, for example, from an incoming call, a low battery warning, an incoming text message, use of input buttons 214, an alarm, a reminder of calendar or task items, etc. Silencing speaker 106 can reduce likelihood of detection and disabling of mobile phone 106 during an alert situation. In addition, as further indicated at block 540, mobile alert application 202 establishes and maintains an open over-the-air voice channel with a predetermined destination, such as a destination telephone number programmed by the user. The destination telephone number can be, for example, a public emergency number (e.g., 911), a private emergency number, the contact number of a third party service provider (e.g., a security service or mobile telephony service provider), or other desired destination. The open voice connection between mobile phone with the destination permits information regarding the alert situation to be received and optionally recorded at the destination, enabling the alert situation to be mitigated, remedied or terminated.

As further indicated at blocks 542-544, mobile alert application 202 also gathers certain data (which may include both constant and variable data), for example, from internal memory device 204, GPS receiver 228, and/or other available data sources. Mobile alert application 202 compiles the data into at least one alert message. As discussed above, in at least some embodiments, the at least one alert message includes an alert text message 208 and/or an alert voice message 206. If utilized, the alert text message 208 is transmitted to one or more pre-selected electronic communication destinations(s) as a text message, and alert voice message 206, if utilized, is transmitted via the open voice channel or another voice channel to one or more pre-selected telephone numbers, which may be entered into mobile alert application 202 using input device 214. Alternatively or additionally, alert text message 208 may be sent by email or instant messaging to one or more pre-programmed email address(es) or instant messaging mailboxes, which may be entered during the setup of mobile alert application 202 using input device 214.

In one embodiment, the data collected at block 542 and utilized to transmit the alert message(s) at block 544 include the following:
(1) Name(s) and electronic communication destination(s) (e.g., telephone number(s), instant messaging mailboxes, and/or email address(es)) to which alert message(s) are to be sent (pre-programmed by user during setup of mobile alert application 202);
(2) Name of the user of user mobile phone 106 (pre-programmed by user during setup of mobile alert application 202 or during initial setup of mobile phone 106);
(3) Photograph (e.g., taken using a camera of user mobile phone 106 or other camera) of the user (pre-programmed by user during setup of mobile alert application 202);
(4) GPS coordinates from GPS receiver 228 and/or from network-provided location services such as AGPS (real-time variable)
(5) Time and date of entry into the alert mode of operation of user mobile phone 106 in response to alert request and/or current time and date (real-time variable)
(6) Telephone number of user mobile phone 106 (pre-programmed by mobile telephony service provider);
(7) Physical description of user of user mobile phone 106 (pre-programmed by user during setup of mobile alert application 202);
(8) Residence address of user of user mobile phone 106 (pre-programmed by user during setup of mobile alert application 202);
(9) Alternate telephone number or other contact information of user (pre-programmed by user during setup of mobile alert application 202);
(10) Any additional text of alert text message 208 (pre-programmed by user during setup of mobile alert application 202); and
(11) Alert voice message 206 (pre-programmed by user during setup of mobile alert application 202).

As further indicated at block 550, in at least one embodiment, mobile alert application 202 also optionally issues an alert relay request via local wireless interface 232 that indicates (i) the identity of mobile phone 106 (e.g., mobile phone 106a) that issued alert relay message (ii) the location of mobile phone 106 (where location can be determined by any available technique, including GPS coordinates, AGPS, triangulation, and/or physical street address), and (iii) a date/time. The alert relay request may optionally further indicate a desired electronic communication destination to which an alert relay message should be directed. The transmission of alert relay requests by mobile phone 106 provides additional security in case mobile phone 106 remains operative, but is removed from a coverage area of the mobile telephony service provider.

As indicated at block 560, mobile alert application 202 repeats the steps depicted at blocks 540-544 and block 550 until a deactivation request is received, for example, through input device 214. The deactivation request can comprise, for example, selection of a menu entry of mobile alert application 202 followed by entry a four-digit security code or PIN. In response to receipt of the deactivation request, the mobile alert application 202 transmits a deactivation command via local wireless interface 232 to deactivate the transmission of alert relay requests by any dots 142 within range (block 562). Thereafter, the process returns to block 502 of FIG. 5A through page connector B.

Thus, mobile alert application 202 causes mobile phone 106a to:
(1) recognize the identity of alert triggering device 130 (e.g., by initially placing alert triggering device 130 within the range of local wireless interface 232 during registration of alert triggering device 130 with mobile alert application 202 and then matching the identity of alert triggering device 130 upon receipt of an alert request);
(2) gather data from internal memory device 204;
(3) compile data into an alert message (e.g., alert text message 208 and/or an alert voice message 206);
(4) send at least one alert message (e.g., alert text message 208 and/or alert voice message 206) to at least one pre-selected electronic communication destination (e.g., telephone number, instant messaging mailbox, and/or email address);
(5) silence speaker 216 of mobile phone 106 so that it will not emit sound in response to an incoming call, a low battery warning, an incoming text message, use of input buttons 214, an alarm, a reminder of calendar or task items, etc.;
(6) maintain an open voice channel following receipt of the alert request in order to allow microphone 212 of user mobile phone 106 to transmit voices and sounds of the alert environment in real time while the incident (e.g., crime) is in progress;
(7) selectively enter an alert mode of operation to communicate by BlueTooth® (or other qualified wireless signal) with other appropriately enabled mobile phones 106 and/or WAPs 126 and cause these other devices to transmit (preferably to an electronic communication destination specified by mobile phone 106a): (i) the identity of user mobile phone 106a, (ii) the location of other mobile phone 106b or WAP 126 (where location can be determined by any available means, including GPS coordinates, AGPS, triangulation, and/or physical street address), and (iii) the date/time;
(8) react to an alert relay request from any other mobile phone 106b operating in the alert mode described above and/or an activated dot 142 by transmitting (preferably to the electronic communication destination indicated by the alert relay request): (i) the identity of user mobile phone 106a, (ii) the location of other mobile phone 106b or WAP 126 (where location can be determined by any available means, including GPS coordinates, AGPS, triangulation, and/or physical street address), and (iii) the date/time;
(9) protect against the unauthorized transmission of the “location” data of the mobile phone 106, particularly when coupled with its “identity”;
(10) deactivate dot(s) 142;
(11) deactivate the alert mode of operation of mobile phone 106 and return user mobile phone 106a to its mode of operation prior to entering the alert mode; and
(12) selectively operate in a tracking support mode to support tracking of unregistered devices.

In at least some embodiments, mobile alert application 202 further supports a query feature in which a mobile phone 106a running mobile alert application 202 wirelessly receives a query request from a mobile phone 106b running mobile alert application 202, and mobile phone 106a responds by reporting its location (e.g., GPS coordinates or physical address) to mobile phone 106b. Each user has the opportunity in the setup menu of mobile alert application 202 to enable (or not) the query feature. If a user chooses to enable the query feature, the user creates a confidential query password in his mobile alert application 202. With appropriate permissions, a user can change the query password at will. Thus, a user of mobile phone 106b that has been given the most current password could use the mobile alert application 202 on mobile phone 106b to query the location of mobile phone 106a, for example, with a text or email message. In response, mobile phone 106a automatically (i.e., without user interaction) transmits to mobile phone 106b a single response (e.g., a text message, email message or other signal) indicating the last recorded location, time/date and ID of mobile phone 106a.

In at least some embodiments, mobile alert application 202 further supports a remote activation feature. With this feature, a mobile phone 106a running mobile alert application 202 receives an “Enter Alert Mode” request from mobile phone 106b, and mobile phone 106a responds by entering the alert mode previously described. Each user has the opportunity in the setup menu of mobile alert application 202 to choose to enable (or not) the remote activation feature. If a user chooses to enable remote activation, the user creates a confidential Remote Activation password in mobile alert application 202. With appropriate permissions, a user can change the Remote Activation password at will. The Remote Activation password is preferably distinct from the query password described above.

With the remote activation feature, mobile phone 106a can be remotely activated by a remote activation request from a distant mobile phone 106b (assuming the user of mobile phone 106b has the most current remote activation password for mobile phone 106a), such that remotely activated mobile phone 106a proceeds to communicate by BlueTooth® (or other wireless signal) with other appropriately enabled mobile phones or other electronic systems and cause these other mobile phones or electronic systems to transmit (i) the identity of activated mobile phone 106a, (ii) the location of the other mobile phones and/or electronic system(s) and (iii) the date/time to the electronic communication destination specified by activated mobile phone 106a.

### Exemplary Use Scenario

An exemplary use scenario is now presented in narrative form to assist in understanding the use and utility of features described herein.

Lilly, a college co-ed, walks alone at night across her college campus toward her car. Her mobile phone rings. She answers and talks to her roommate Margaret as she walks. Lilly enters a big parking lot. She says good-by, hangs up and puts her mobile phone in her pocket. Lilly sees her car ahead and reaches for her car keys. Attached to her key ring is a Spitfire® pepper spray dispenser equipped with an Alert button.

A man steps out from behind a truck without speaking. Lilly's fingers close around the Spitfire® pepper spray dispenser and her thumb rests on the Alert button. The man comes directly at her. “STOP!” she shouts. He speeds up. Lilly presses the Alert button. As she steps out of his line of attack, Lilly points her Spitfire® pepper spray dispenser at his face and pushes the firing button. Oleoresin capsaicin (OC) blasts out in a cone of spray that covers the attacker's face. He never sees it coming.

He stops and rubs his burning eyes with both hands; he gags and chokes. He cannot see! Blindness, pain and panic defeat his plan to hurt Lilly. Lilly does not see the coward's accomplice sneaking up behind her. He knocks her unconscious with a pipe.

When Lilly regains consciousness, a strip of duct tape seals her mouth, and another strip of the duct tape covers her eyes. Her wrists are taped together behind her back and her ankles are bound. She realizes that she is in a moving vehicle. She hears two angry men arguing in loud voices. Lilly hopes her mobile phone is still in her pocket. When Lilly pushed the Alert button on her Spitfire® pepper spray dispenser, Lilly's mobile phone was activated to send one or more alert messages to one or more electronic communication destinations, including the University Police Department (“UPD”) telephone number. One of the alert messages was transmitted as a text message, another by email, and a third alert was transmitted as a mobile phone call playing a pre-recorded voice message. The attackers had no warning that the alert messages were sent because Lilly's mobile phone was not visible to them at the time of the attack.

Sergeant Mack Young is on duty at the UPD dispatching desk when the alert messages arrive. Here is what Sgt. Young heard on the telephone and read as a text message and/or email message on his computer display:
TO: UNIVERSITY POLICE DEPARTMENT . . . TEL: 512.555.5555 THIS IS AN EMERGENCY. HELP!!! I AM LILLY A. WALKER. ATTACHED IS MY PHOTOGRAPH. DISPATCH POLICE IMMEDIATELY to MY LOCATION: [GPS coordinates and/or physical address] TIME: 11:02:45 PM . . . SAT . . . OCTOBER 27, 2007 INITIATE TRACKING OF MY MOBILE PHONE # 512.555.5556 RECORD MY MOBILE PHONE CALL because the microphone is transmitting real time information from the crime scene. MY DESCRIPTION: FEMALE . . . WHITE . . . AGE 19 . . . BRUNETTE MY RESIDENCE ADDRESS: 801 W 24th St, UNIVERSITY TOWERS ROOM 219, Anywhere, Anystate 55555 MY ALTERNATE TELEPHONE: 512.555.5557 I am sending you one or more simultaneous textual messages and a pre-recorded VOICE mobile phone call. END.

Sergeant Mack Young quickly copies the GPS coordinates from the alert message on his computer monitor and pastes it into mapping software. A graphic map showing Lilly's location appears on his computer monitor, and Mack wirelessly forwards this map and the alert message to the mobile computer in the patrol car nearest the scene. Lilly's photograph appears on their computer displays as an attachment to text message/email.

Two seasoned UPD officers in the patrol car see the map and the text message/email on their computer display as they hear Sgt. Young's voice on their radio dispatching them to the GPS location of the attack on Lilly. When the patrol car arrives, no one is at the crime scene.

Lilly hears one attacker complaining frequently about his burning eyes and the pain caused by the OC pepper spray. She also hears them arguing about who will do what to her when they arrive at the park by the river. Sgt. Young patches to the UPD patrol car radio the voices of two men arguing. The officers listen in real time to the plans of Lilly's attackers being broadcast through the microphone of her mobile phone. The men name a certain riverside park where they plan to assault Lilly and sink her body in the river. Incoming GPS coordinates transmitted from Lilly's mobile are presented on the computer map in the UPD patrol car and reveal the path of the van headed for that park. The patrol car races away toward the park they named.

Margaret decides to call Lilly back, so she picks up her phone and calls Lilly's mobile phone number. Margaret is not aware that if her incoming call causes Lilly's mobile phone to begin ringing or vibrating, the criminals may hear the noise, find the mobile phone and throw it away. Margaret hears Lilly's recorded voice mail announcement inviting her to “leave a message after the beep”. In the van, Lilly's mobile phone is silent. No one in the van is aware of Margaret's incoming call.

One of the attackers crawls into the back of the van next to Lilly. He searches her pockets. When he finds her mobile phone, he removes the battery. Then, he rummages through her purse and removes her money, credit cards and driver's license. He throws the purse with its remaining contents out a window of the moving vehicle. Lilly is relieved that he did not notice her small hair clip.

In the UPD patrol car, the voices from the van fall silent, and no further GPS coordinates from Lilly's mobile phone are received. However, GPS coordinates from other sources continue to appear on the computer map.

The van enters the cold, dark park by the river. Only the bright headlights of one approaching vehicle can be seen as it passes them on its way out of the park. The van turns right down a winding single lane road and passes an empty car parked on the shoulder. The winding road ends at the edge of a field not far from the river bank. When the van stops, Lilly opens her eyes. Her eyelashes brush across the sticky underside of the duct tape.

The criminals pull Lilly roughly out of the rear of the van and down to the ground. They cut the duct tape binding her ankles and jerk her back up to her feet. They begin taunting and pushing her. Lilly trips and falls backward. Blinded by the tape and without her hands free to break the fall, Lilly hits hard. They continue their threats while dragging her across a field toward the river.

The UPD patrol car computer receives fresh GPS coordinates showing Lilly's location in the park, and then, a second set of still fresher GPS coordinates show up on their computer map indicating Lilly's last location in the park. Where are these GPS coordinates coming from? When Lilly first pressed the Alert button on her Spitfire® pepper spray dispenser at the beginning of the attack, it activated a dot hidden in the small hair clip holding back her hair. Each time the van carried Lilly close to an appropriately enabled GPS mobile phone or other wireless device, her dot wirelessly communicated an alert relay request that caused the other wireless device to transmit her identity, location and the time/date by text messaging and email to the telephone number/email address pre-selected by Lilly on her mobile phone. This happens when the first vehicle with the bright headlights is departing the park and passes by the van carrying Lilly, and the same thing happens again as the van carrying Lilly passes by an empty parked vehicle waiting on the shoulder of the winding road. An appropriately enabled GPS mobile phone is inside each of those vehicles in the park.

The computer map in the UPD patrol car reveals to the officers that they are very close to Lilly's last reported position. Suddenly, Lilly hears loud voices booming, “Police!” In the midst of much shouting, she drops to the ground. A couple of long minutes later, she hears a strong voice ask: “Lilly, are you OK?” Duct tape is carefully peeled off her eyes and mouth. Her wrists are freed. Sparkling red and blue strobe lights flash along the river bank as more patrol cars bounce across the field toward her. A UPD police officer finds Lilly's mobile phone and battery in the back of the van. He reinstalls the battery gives the mobile phone back to her. When Lilly turns on her mobile phone and reestablishes communication with the UPD, Sgt. Mack Young at the UPD dispatching desk hears the same thing over the cell voice line that the UPD officers hear over their radios in the park: “This is Lilly Walker. I'm OK. Thank you for saving me.”

As has been described, according to one method of operation, a mobile phone wirelessly receives an alert request from a separate alert triggering device via a first wireless interface of the mobile phone. In response to the alert request, the mobile phone automatically transmits an alert message utilizing wireless radio frequency communication via a second wireless interface of the mobile phone and a wireless wide area network. The communication of alerts can further be supported by the viral transmission of alert relay requests that propagate opportunistically in an attempt to reach a communication device, such as a mobile phone or WAP, that is capable of delivering an alert relay message to an electronic communication destination.

While various features have been particularly shown and described with reference to various exemplary embodiments, it will be understood by those skilled in the art that various changes in form and detail may be made therein without departing from the spirit and scope of the claimed inventions. For example, embodiments have been described with respect to machine processing of program code that directs various functions, it should be understood that another embodiment is a program product storing program code that, when processed or executed by a machine, directs such functions. Program code can be delivered to a machine via a variety of storage media, including, without limitation, non-rewritable storage media (e.g., CD-ROM) and rewritable storage media (e.g., flash memory or hard disk drive).

What is claimed is:

1. A method of operating a mobile phone, comprising:
the mobile phone wirelessly receiving an alert request from a separate alert triggering device via a first wireless interface of the mobile phone; and
in response to the alert request, the mobile phone automatically transmitting an alert message utilizing wireless radio frequency communication via a second wireless interface of the mobile phone and a wireless wide area network.

2. The method of claim 1, wherein:
the method further comprises determining if the alert triggering device is registered with the mobile phone; and
the transmitting includes transmitting the alert message if the alert triggering device is registered with the mobile phone and otherwise refraining from transmitting the alert message.

3. The method of claim 1, wherein:
the method further comprises the mobile phone storing an electronic communication destination for the alert message in advance of receipt of the alert request; and
the transmitting includes transmitting the alert message to the electronic communication destination via the wireless wide area network.

4. The method of claim 1, wherein:
the mobile phone includes a memory device containing predetermined data; and
the transmitting includes transmitting a textual alert message including the predetermined data.

5. The method of claim 1, wherein:
the mobile phone includes a memory device containing predetermined data; and
the transmitting includes transmitting an audio alert message including the predetermined data.

6. The method of claim 1, wherein:
the method further comprises the mobile phone receiving a GPS signal; and
the transmitting includes transmitting in the alert message a geographical location determined by reference to the GPS signal.

7. The method of claim 1, and further comprising the mobile phone wirelessly transmitting an alert relay request requesting another device to transmit an alert relay message to an electronic communication destination.

8. The method of claim 7, wherein wirelessly transmitting the alert relay request includes transmitting in the alert relay request an indication of the electronic communication destination.

9. The method of claim 1, and further comprising:
the alert triggering device transmitting the alert request in response to manual actuation of an actuator of the alert triggering device.

10. A program product, comprising:
a tangible data storage medium; and
program code stored within the tangible data storage medium that causes a mobile phone to wirelessly receive an alert request from a separate alert triggering device via a first wireless interface of the mobile phone and, in response to the alert request, automatically transmit an alert message utilizing wireless radio frequency communication via a second wireless interface of the mobile phone and a wireless wide area network.

11. The program product of claim 10, wherein the program code causes the mobile phone to determine if the alert triggering device is registered with the mobile phone and transmit the alert message only if the alert triggering device is registered with the mobile phone.

12. The program product of claim 10, wherein the program code causes the mobile phone to transmit the alert message via the wireless wide area network to an electronic communication destination stored in the mobile phone in advance of receipt of the alert request.

13. The program product of claim 10, wherein the program code causes the mobile phone to transmit a textual alert message including predetermined data contained in a memory device of the mobile phone.

14. The program product of claim 10, wherein the program code causes the mobile phone to transmit an audio alert message including predetermined data contained in a memory device of the mobile phone.

15. The program product of claim 10, wherein the alert message includes a geographical location determined by the mobile phone by reference to a GPS signal.

16. The program product of claim 10, wherein the program code further causes the mobile phone to wirelessly transmit an alert relay request requesting another device to transmit an alert relay message to an electronic communication destination.

17. The program product of claim 16, wherein the alert relay request includes an indication of the electronic communication destination.

18. A mobile phone, comprising:
a processor;
a first wireless interface;
a second wireless interface to a wireless wide area network;
a memory device coupled to the processor; and
a program code within the memory device that when processed by the processor causes the mobile phone, responsive to wirelessly receiving an alert request from a separate alert triggering device via the first wireless interface, to automatically transmit an alert message utilizing wireless radio frequency communication via a second wireless interface and the wireless wide area network.

19. The mobile phone of claim 18, wherein the program code causes the mobile phone to determine if the alert triggering device is registered with the mobile phone and transmit the alert message only if the alert triggering device is registered with the mobile phone.

20. The mobile phone of claim 18, wherein the program code causes the mobile phone to transmit the alert message via the wireless wide area network to an electronic communication destination stored in the memory device in advance of receipt of the alert request.

21. The mobile phone of claim 18, wherein the program code causes the mobile phone to transmit a textual alert message including predetermined data contained in the memory device of the mobile phone.

22. The mobile phone of claim 18, wherein the program code causes the mobile phone to transmit an audio alert message including predetermined data contained in the memory device of the mobile phone.

23. The mobile phone of claim 18, wherein:
the mobile phone further includes a GPS receiver that receives a GPS signal; and
the alert message includes a geographical location determined by the mobile phone by reference to the GPS signal.

24. The mobile phone of claim 18, wherein the program code further causes the mobile phone to wirelessly transmit an alert relay request requesting another device to transmit an alert relay message to an electronic communication destination.

25. The mobile phone of claim 24, wherein the alert relay request includes an indication of the electronic communication destination.

26. A system, comprising:
the mobile phone of claim 18; and
an alert triggering device having an actuator, wherein the alert trigger device, responsive to manual actuation of an actuator, transmits the alert request.
